(19) United States
(12) Patent Application Publication
(10) Pub. No.: US 2019/0223125 A1
(43) Pub. Date: Jul. 18, 2019

(54) MEASUREMENT SYNCHRONIZATION ACROSS NETWORKS

(71) Applicant: Linear Technology Holding LLC, Norwood, MA (US)

(72) Inventor: Jonathan Noah SIMON, Alameda, CA (US)

(21) Appl. No.: 15/870,784

(22) Filed: Jan. 12, 2018

(51) Int. Cl. H04W 56/00

(52) U.S. Cl. CPC H04W 56/0015; H04W 84/18

(57) ABSTRACT

A mesh network system for measurement synchronization across networks is provided. The subject technology relates to measuring a timing error of each wireless mesh network relative to a backbone network, thereby tracking the difference in time between the networks. Devices of each mesh network initiate measurements at a time that is based on the measured timing error for that network. As such, the measurements can occur at a same time across the mesh networks. For example, a backbone network mote determines that a measurement is to be obtained at a particular rate, and the backbone network motes all agreed that the starting time is set to a common network time. The backbone network mote then measures a network manager and sends a message to the motes underneath that network manager providing a clock offset and time interval to the motes for adjusting a rate at which the measurements are obtained.

### FIELD OF THE DISCLOSURE

The present application generally relates to wireless mesh networks, and more particularly, but not exclusively, to measurement synchronization across networks.

### BACKGROUND

Wireless mesh networks provide a high level of flexibility in network design and in the resulting range of applications for which the networks can be used. In a mesh network, nodes automatically detect and establish communications with neighboring nodes to form the wireless mesh. A network manager can coordinate the operation of the wireless mesh network, such as to coordinate the timing of the nodes and establish communication links between nodes. The network manager may also serve as a gateway between the wireless mesh network and elements external to the mesh network.

In one example, nodes of a wireless mesh network each include a sensor and are operative to relay sensor data measurement through the network. In the example, a network manager provides an interface between the wireless mesh network and an external network (e.g., a local area network (LAN)), and enables a computer connected to the external network to receive the sensor data measurement from all of the wireless mesh network nodes.

In some distributed time base topologies, there is a two-level approach. At one level, there may be one network at a backbone for communicating to local sub networks. At a second level, the local sub networks may report data up to the backbone to a centralized controller so that the data can be sent out to another system. All of the devices of that network can agree on a time with the other devices in their network (e.g., to within two microseconds) such that the synchronization within an individual small network may be fairly accurate. However, these devices are not tied to an absolute time reference. When multiple small networks are communicatively coupled to the backbone, each of the local sub networks will have their own time base. While the devices within that small network can agree with each other with fair accuracy, the devices do not have any notion what the time is relative to the devices in the backbone, and conversely, the devices in the backbone do not have any insight as to what the time is relative to the time used by the small networks, such that accurate measurement synchronization between physically separated sections of a network can be difficult.

### SUMMARY OF THE DISCLOSURE

The subject technology relates to measuring a timing error of each wireless mesh network relative to a backbone network, thereby tracking the difference in time between the networks. Devices of each mesh network initiate measurements at a time that is based on the measured timing error for that network. As such, the measurements can occur at a same time across the mesh networks. For example, a backbone network mote determines that a measurement is to be obtained at a particular rate, and the backbone network motes all agreed that the starting time is set to a common network time. The backbone network mote then measures a network manager and sends a message to the motes underneath that network manager providing a clock offset and time interval to the motes for adjusting a rate at which the measurements are obtained.

According to an embodiment of the present disclosure, a method of synchronizing measurements across networks is provided. The method includes receiving, by a mote of a backbone network, timing information from a network manager device of a wireless mesh network associated with the backbone network. The method includes determining, by the mote of the backbone network, a rate at which a clock of the network manager device is drifting in time relative to a backbone network time of the backbone network from the received timing information. The method also includes transmitting, by the mote of the backbone network, based on the determined rate, correction information to devices managed by the network manager device through the network manager device to adjust a rate at which measurements are made at the devices such that the devices obtain measurements at respective times synchronized with each other based on the correction information.

According to an embodiment of the present disclosure, a mesh network system includes a plurality of motes of a backbone network, where each of the plurality of the motes of the backbone network includes a processor and a wireless transceiver configured for wireless communication with the backbone network. The mesh network system also includes a plurality of network manager devices communicatively connected to the plurality of motes of the backbone network and each of the plurality of network manager devices is configured to manage operation of an individual wireless mesh network including node devices of the individual wireless mesh network. In some aspects, each of the plurality of motes of the backbone network is operative to receive timing information from respective ones of the plurality of network manager devices and transmit a clock offset correction and a drift rate correction to node devices managed by each of the plurality of network manager devices through the respective ones of the plurality of network manager devices to adjust a rate at which measurements are made at the node devices such that the node devices obtain measurements at respective times synchronized with each other based on the clock offset correction and the drift rate correction.

According to an embodiment of the present disclosure, a mesh network system includes means for determining a common backbone network time. The mesh network system also includes means for obtaining timing information from a network manager device associated with a wireless mesh network. The mesh network system also includes means for determining that a clock of the network manager device has an offset relative to the common backbone network time based on the obtained timing information. The mesh network system also includes means for determining that the clock of the network manager device is drifting in time relative to the common backbone network time based on the obtained timing information. The mesh network system also includes means for determining a clock offset correction for the determined clock offset and a drift rate correction for the determined drifting of the network manager device. Finally, the mesh network system also includes means for pushing the clock offset correction and the drift rate correction to node devices of the associated wireless mesh network through the network manager device to adjust a rate at which measurements are made at the node devices such that the node devices obtain measurements at respective times synchronized with each other based on the clock offset correction and the drift rate correction.

Additional advantages and novel features will be set forth in part in the description, which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

Certain features of the subject technology are set forth in the appended claims. However, for purposes of explanation, several embodiments of the subject technology are set forth in the following figures.

FIG. 1 is a high-level functional block diagram of an illustrative wireless mesh network.

FIG. 2 is a high-level functional block diagram of an illustrative wireless mesh network including a backbone network for measurement synchronization across networks in accordance with one or more implementations.

FIG. 3 is a high-level diagram illustrating a structure of a packet used in the wireless mesh network system of FIG. 2 in accordance with one or more implementations.

FIGS. 4A-4C are high-level functional block diagrams of an illustrative wireless node, an illustrative access point, and an illustrative network manager such as may be used in the wireless mesh network systems of FIGS. 1 and 2 in accordance with one or more implementations.

FIG. 5 is a high-level flow diagram showing steps of an example process illustrating the functioning of the wireless mesh network system of FIG. 2 in accordance with one or more implementations.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

As used herein, the term “backbone network” may refer to a portion of a computer network that interconnects one or more networks to one or more external networks by providing a path for the exchange of information between the networks and the external networks. The networks may include a wireless mesh network, a local-area network (LAN), wide-area network (WAN)) or multiple operably connected servers.

A wireless network may include multiple sensor nodes, called “motes,” that are configured to communicate with other connected nodes in the wireless network. The terms “nodes” and “motes” may be used interchangeably without departing from the scope of the disclosure. As used herein, the term “backbone network time” may refer to an absolute reference time determined by motes of a backbone network, such that time and timing information utilized within diverse wireless mesh networks branched from the backbone network can be determined relative to the backbone network time. As used herein, the term “drift” may refer to a continuous movement of a clock time or timer relative to a clock source. As used herein, the term “drift rate” may refer to the rate at which such continuous movement is changing as a function of time.

The subject technology relates to wireless mesh networks that are very low power and provide a distributed time base with relative accuracy. All of the devices of an individual wireless mesh network share a time base that is accurate to within a small number of microseconds. This can be achieved for tens of microamperes of average current. There are other distributed ways of doing time synchronization, however, having the devices be wireless and operate at very low power to thereby achieve microsecond accuracy at microampere current is uncommon. While the devices within an individual mesh network can agree with each other with fair accuracy, the devices do not have any notion what the time is relative to the devices in the backbone network. For example, each node derives time from wireless packets within its own network. Since each local network manager is on its own wireless time base, synchronization across all nodes uses a mechanism for synchronizing across the wireless-to-wired domain (i.e., from a backbone mote to a local network manager). This can be done by measuring relative to the backbone network and using that information.

The subject technology provides for a mechanism that enables a device of a backbone associated with multiple wireless mesh networks to measure and adjust the rate at which measurements are performed by devices in the individual mesh networks based on the relative drift of that mesh network in order to achieve the synchronization that is desired. Rather than continually accounting for the difference in time between the local sub networks, the subject system measures the rate at which the local sub networks are drifting and triggers a correction to the frequency, as opposed to making a correction for the absolute time error. Measuring the frequency allows the subject system to send fewer messages to make these corrections and, thereby, reduces the cost of system resources for synchronizing measurements across networks.

A backbone mote (or device) performs synchronized measurements across multiple individual wireless mesh networks. In order to synchronize the measurements across the individual wireless mesh networks with different drift, a backbone network is used to measure their drift and correct the offset and rate at which the measurements are taken in the individual wireless mesh networks.

The backbone network may have multiple motes (or wireless nodes). Each mote in the backbone network may be connected to a network manager device (“network manager”) in another isolated wireless mesh network. Within each mesh network, each local network manager device (“local network manager”) has an offset relative to the backbone network, and may be drifting relative to the backbone network. For example, a clock of a first local network manager may be 10 minutes behind the backbone network time, and drifting at a rate of +40 ppm relative to the backbone network. That means that motes in that individual wireless mesh network are gaining about 1.2 milliseconds (ms) every 30 seconds relative to the backbone network motes.

In some implementations, all of the local network managers (e.g., the device clocks) are synchronized to a same time base (e.g., the backbone network time). In some aspects, the synchronization to the same time base may be performed using geolocation information (e.g., GPS) on each local network manager, but this approach may add cost, power, and complexity. For example, it costs a lot of power to maintain a very precise time base, e.g., using GPS or a highly accurate clock.

In some implementations, each of the motes in the backbone network agree on a time to within a few microseconds, so a backbone network time can be used as the time base for measuring the drift of each local network manager by using a hardware timestamp pin on the local network manager. In some aspects, the backbone network mote associated with that local wireless mesh network can send a broadcast command to the isolated wireless mesh network to notify the associated motes of that network to perform measurements at an offset and interval that accounts for that particular manager's drift. The local network manager's drift may be largely constant with temperature, so the drift measurement can be performed relatively infrequently (e.g., when the temperature changes by 10° C.).

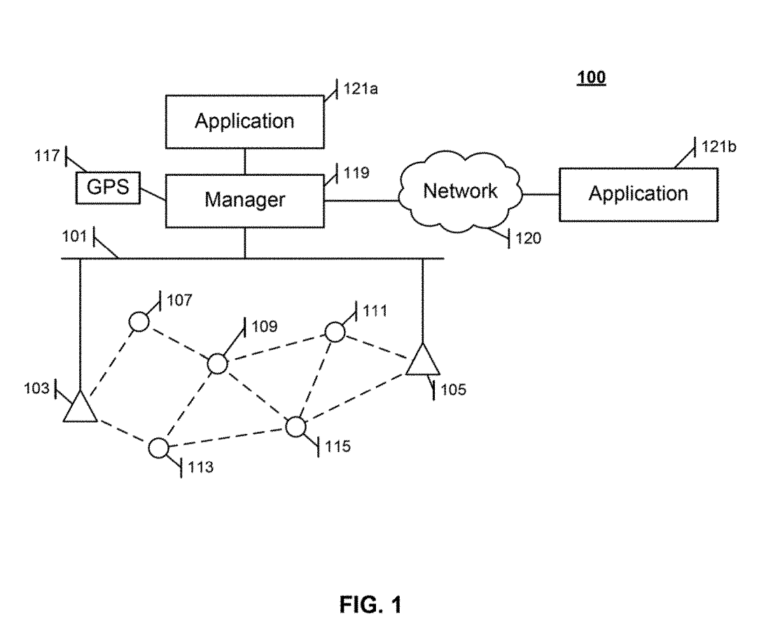

FIG. 1 shows an illustrative wireless mesh network 100 that includes wireless mesh network nodes 107, 109, 111, 113, and 115, also referenced as motes, that communicate with each other through wireless links (shown in dashed lines) in a wireless mesh network 101. Each node or mote includes a wireless transceiver. A node operating as a sensor node includes a sensor and generates data packets including sensor measurement data for transmission across the wireless mesh. The same or another node can operate as an actuator or control node that includes an actuator or controller and receives control packets through the wireless mesh.

The wireless mesh network 100 additionally includes one or more wireless access points (APs) 103 and 105. An AP can have wireless links to both nodes and to other APs. Additionally, each AP serves as an interface or gateway between the wireless mesh network 100 (including nodes 107, 109, 111, 113, and 115) and elements external to the mesh network. For example, the APs may provide an interface between the wireless mesh network 100 and an external network (e.g., 120) that may be wired or wireless. In the example shown, the APs communicate with a network manager device 119 across wired links (shown in solid lines) and with one or more host applications 121a and 121b. The communications of the APs with the network manager device 119 and/or host applications 121a and 121b may be routed through an external network 120 such as the Internet. Note that the communication links between the APs, network manager device 119, and/or host applications 121a and 121b may be wired links or wireless links such as WiFi or cellular connections. In some implementations, the AP (e.g., 103, 105) and the network manager (e.g., 119) may be functions of a same semiconductor chip (or die), where a management process handles the management and the LAN/WAN connection, and the AP process handles driving the radio transceiver. In this respect, the AP and the network manager may be logical elements rather than distinct devices connected by a network.

In some implementations, the network manager device 119 coordinates the operation of the wireless network devices (nodes and APs) to efficiently communicate with each other, and assigns bandwidth (e.g., channels and timeslot pairs) and network addresses (or other unique identifiers) to network nodes and APs to enable coordinated network communication. In detail, the network manager device 119 is responsible for controlling operation of the wireless mesh network 100. For example, the network manager device 119 may establish and control network timing (e.g., by selecting whether the network will function according to an internal clock of an AP or an external clock, and configuring the APs to synchronize to the appropriate selected clock). The network manager device 119 may also determine which devices (e.g., nodes and access points) can participate in the network by selectively joining nodes and access points to the network, assigning network addresses (or other unique identifiers (ID)) to the joined devices, and setting the communication schedule for the network by assigning bandwidth to different devices of the network. The communication schedule may assign pairs of timeslots and channels to the devices (e.g., wireless nodes 107 and APs 105) of the network, to thereby identify which device can communicate on each channel during each timeslot of the network clock. Additionally, the communication schedule may assign pairs of timeslots and channels that form a “join listen” bandwidth during which wireless nodes seeking to join the network can send network join messages, and during which wireless nodes already joined to the network listen for such network join messages.

One or more of the APs 103 and 105 may optionally be communicatively connected to an external time source such as a GPS time source 117. In FIG. 1, for example, AP 105 is connected to the GPS time source 117 to enable the AP 105 to synchronize its clock to the GPS time reference. In this respect, AP 105 is externally clocked. In one example, the other AP 103 may receive a clock reference, such as a clock reference synchronized to the GPS time source 117, from wireless communication with the mesh network.

In operation, data generated in the mesh network nodes 107, 109, 111, 113, and 115 may flow through the mesh network 100 to any of the APs 103 and 105. Additionally, data generated at the network manager device 119 or host application 121a, 121b for transmission in the mesh network 100 may flow, equivalently, from any of the APs 103 and 105 to its destination node.

The wireless mesh sensor network 100 enables the collection of sensor measurement data (and/or application data) from multiple sense points at which sensor nodes are located. The network 100 enables the collection of sensor data by building a multi-hop mesh of communication links using the nodes. Data sent from distant nodes may be automatically routed through the mesh by having each node retransmit received packets topologically closer to each packet's destination. Alternatively, each node may retransmit received packets on the node's next communication opportunity, as determined based on a network node communication schedule established by the network manager device 119 for the network, regardless of the destination node associated with the next communication opportunity. Each transmission and reception of a packet between a pair of nodes may be called a hop, and data packets may take different multi-hop routes through the mesh to their destination. In general, the destination of a packet including sensor data transmitted from a node in the mesh network is the AP of the wireless mesh network 100, and the route followed by the packet depends on path stability and the network node communication schedules. By a similar process, sensor application data and other packets (e.g., from the host application 121a, 121b) propagate through the mesh network in the opposite direction, e.g. from an AP to a sensor node serving as a destination node.

In a wireless mesh network having a single AP (e.g., 105), the network may be established and begin operation when the AP is powered up and receives a network identifier and network node communication schedule indicative of the network's wireless links from the network manager device 119 over the wired AP-manager interface. After receiving the network identifier and network node communication schedule, the single AP may be responsible for setting the time reference in the network, and may begin sending out network advertisements based on the AP's own time reference (e.g., the AP's internal clock) in advertisement packets which serve both to advertise the network and to enable nodes seeking to join the network to synchronize their clocks to the network time reference set according to the AP's clock.

When a node is first powered up, the node may go through a mesh network searching and joining process. The first part of the searching and joining process may involve the node listening for advertisements from any existing mesh networks in its vicinity and synchronizing its internal time reference (e.g., clock) to the time reference of a wireless mesh network from which an advertisement packet is received. Once synchronized, the node engages in a security handshake with the manager device 119 of the wireless mesh network it is seeking to join. The security handshake may involve exchanging multiple packets, which are sent back-and-forth through the wireless mesh, between the joining node and the manager device 119. At the end of this handshaking, the manager device 119 may add wireless links in the network node communication schedule to provide opportunities for the joining node to receive and/or send packets through the wireless mesh network, so as to allow the joined node to participate in the network and to advertise for other nodes to join.

As described in relation to FIG. 1, the wireless mesh network 100 can include multiple APs (e.g., 103, 105). In such a network, the network has multiple egress points for packets to pass from the wireless mesh network 100 to a manager device 119 or host application 121a, 121b, and multiple ingress points for packets to pass from the manager device 119 or host application 121a, 121b to the nodes in the wireless network. As such, the network may be able to support more packets per second being received from the network and more packets per second being sent into the network. Furthermore, the network may exhibit higher reliability since, unlike a network having a single AP, the network does not have a single-point-of-failure (in the network having a single AP, a failure of the AP will inhibit further network operation).

Additionally, the use of multiple APs may enable the network to support more nodes with a single manager device 119 than a corresponding network having a single AP. In one example, a wireless mesh network having a single AP may be able to support a maximum number of nodes (e.g., 100 nodes) and a maximum throughput (e.g., 36 packets per second of upstream data) based on constraints imposed by the network hardware, communication and network protocol, and the like. Further, the network having the single AP may fail completely if the network's AP fails. However, by installing multiple APs (e.g., 12 APs) in the single network, the manager may be able to support more nodes (e.g., 12*100=1200 motes in our example) and more data throughput (e.g., 12*36=432 packets per second of upstream data) under the same conditions. Furthermore, if any of the multiple APs (e.g., 12 APs) fail, the network may be able to continue to operate with only a small decrease in available performance, which may or may not affect the host application.

In some implementations, the wireless mesh network 100 can include a backbone network and a backbone network manager. In such a network, the backbone network manager may include multiple motes, where each mote is connected to a manager (e.g., 119) in another isolated wireless mesh network.

However, for a backbone network manager having multiple local network managers, all network managers and nodes may have to operate according to a same time reference in order to make synchronized measurements across multiple individual wireless mesh networks. Indeed, for all network managers and nodes to make measurements at the same time, the network managers and nodes can be synchronized to the same time reference used to initiate measurements locally. Hence, the multiple network managers in the network will generally have to be set to a same time base (e.g. to within a few microseconds), such that all local network managers can be synchronized. However, each of the different local network managers has a different clock offset relative to the backbone network manager, and each is drifting relative to the clock of the backbone network manager. For example, the network manager device 119-1.

In accordance with an approach for synchronization between network managers in a wireless mesh network, an external time reference can be used. For example, a GPS time reference (e.g., 117), UTC time reference, or other accurate time base may be used. In the example of FIG. 1, one network manager device 119 may be in direct communication with the external time reference and may synchronize its clock to the external time reference. In other examples, all of the network managers may be in direct communication with the external time reference and may synchronize their clocks to the external time reference. However, this approach adds cost, power, and complexity.

The subject technology provides for measurement synchronization across wireless mesh networks by using a backbone network time as a time base for measuring the drift rate of each local network manager. For example, each of the local network managers can have their internal representation of the network time modified periodically according to offset and drift rate information provided in data packets transmitted from a corresponding backbone network mote that is synchronized to a backbone network time. In some aspects, the motes in the backbone network keep time via exchanging data messages, which can have an empty payload (also referred to as “keepalive” packets).

In some implementations, a local network manager drifts at a particular rate relative to the backbone. For example, each local network manager has its own drift relative to the backbone. All the motes underneath a particular network manager follow that manager's drift based on a network algorithm. The subject technology provides for a mechanism that correlates the individual managers' time base relative to the backbone time base and for conveying that information to the networks without having to actually align the managers to one another.

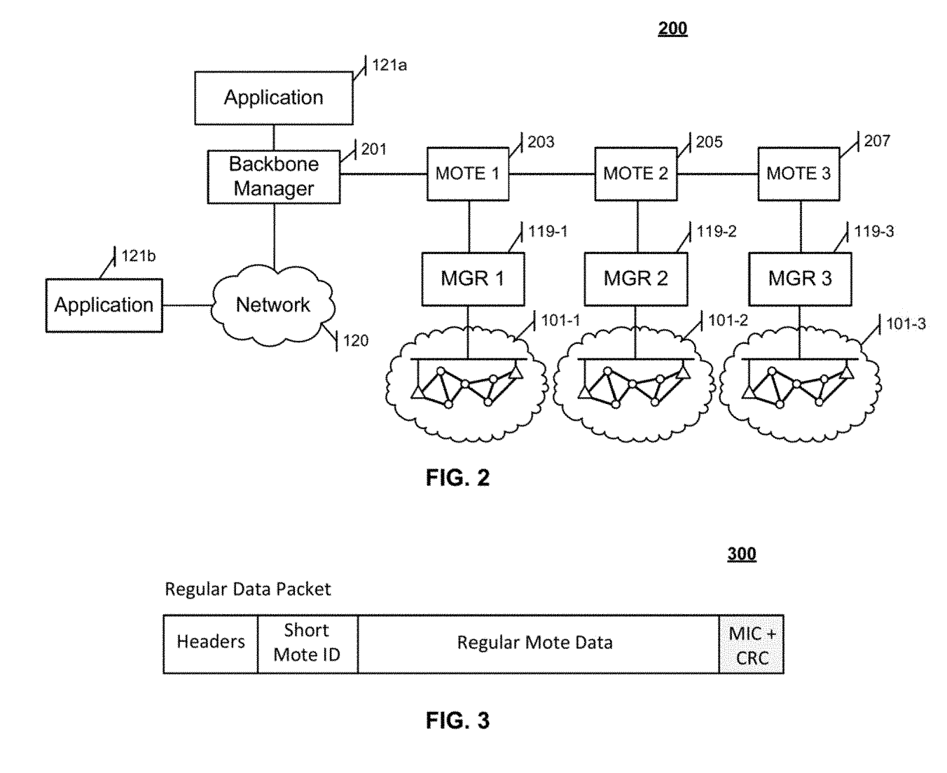

In cases in which the network time is set according to the backbone network time and the local network managers have their internal clocks modified at an offset and interval, the time reference used by each network node may track the backbone network time when compensated for the local network's own drift. The synchronization to the backbone network time by offset and drift rate adjustments may be especially useful in situations in which a backbone network managed by a single network manager includes physically separated clusters of devices (sub-nets), for example in a situation in which each mote of the backbone network is connected to one of the multiple local network managers in a geographically distinct location and the local network manager serves as a network gateway for a set of network nodes in the geographically distinct location, as illustratively shown in FIG. 2 (discussed in further detail below).

FIG. 2 shows an illustrative wireless mesh network 200 that is similar to the wireless mesh network 100 of FIG. 1, and components and functions of the network 200 operate in substantially similar ways as corresponding components of the network 100. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided.

The wireless mesh network 200 includes wireless mesh networks 101-1, 101-2, and 101-3, which are operatively coupled to network manager devices 119-1, 119-2, and 119-3, respectively. In the wireless mesh network 200, the wireless mesh networks 101-1, 101-2 and 101-3 form physically separated clusters of devices, and devices of one cluster (sub-net) may not communicate with the devices of another cluster (or sub-net) such that all nodes and devices in the geographically distinct locations are isolated from one another. In such situations, the network manager devices (e.g., 119-1, 119-2 and 119-3) may not communicate with each other through direct wireless communication.

In the case of geographically distributed mesh networks, a single mesh network may be defined based on the following criteria. Two devices (e.g., nodes) may be considered to be in the same network if: the devices share a common time reference that is sufficiently precise to enable the devices to communicate with each other wirelessly; the devices share a common network communication schedule, a common network ID, a common security protocol (including encryption/decryption/security keys), a common frequency blacklist, and are assigned network addresses (or other unique identifiers such as MAC addresses or node IDs) that are compatible for use on the same network; and/or the devices can communicate with each other and have been assigned opposite transmit and receive links in the same time slot and on the same channel offset in a network node communication schedule.

The wireless mesh network 200 includes one or more network nodes 203, 205, and 207, also referenced as backbone network motes, which communicate with the backbone network manager 201. A backbone network mote can have wireless links to both the backbone network manager 201 and to other backbone network motes. Additionally, each backbone network mote serves as an interface or gateway between the network manager devices 119-1, 119-2, 119-3 (including wireless mesh networks 101-1, 101-2, 101-3) and a backbone network. For example, the backbone network mote may provide an interface between the wireless mesh network 101-1 and the backbone network manager 201 that may be wired or wireless. In the example shown, the backbone network motes 203, 205, 207 communicate with the network manager devices 119-1, 119-2, 119-3, respectively, across wired links (shown in solid lines) and with one or more host applications 121a and 121b. The communications of the backbone network motes (e.g., 203, 205, 207) with the host applications 121a and 121b may be routed through an external network 120 such as the Internet. Note that the communication links between the backbone network motes (e.g., 203, 205, 207), the network manager devices (e.g., 119-1, 119-2, 119-3), and/or host applications 121a and 121b may be wired links or wireless links such as WiFi or cellular connections. It will be appreciated that the discussion below is primarily in reference to the backbone network mote 203, the local network manager device 119-1, and the local sub network 101-1 for clarity and explanatory purposes, but the scope of the disclosure is not limited to the elements identified in the discussion.

The wireless mesh network 200 additionally includes a backbone network manager 201 that coordinates the operation of motes on the backbone to enable coordinated measurement operations with local sub mesh networks. In detail, the backbone network manager 201 is responsible for controlling operation of the backbone network motes (e.g., 203, 205, 207). For example, the backbone network manager 201 may establish and control measurement timing (e.g., by measuring both the offset and drift of individual mesh networks and pushing correction information to the mesh networks in order to synchronize the time at which measurements are obtained by the individual mesh networks). The backbone network manager 201 may also determine which motes on the backbone can participate in the network by selectively joining motes to the backbone network, assigning network addresses (or other unique identifiers (ID)) to the joined motes, and setting a communication schedule for the backbone network by assigning bandwidth to different motes of the backbone network.

As illustrated in FIG. 2, the backbone network mote 203 (e.g., MOTE 1) is physically connected to the local network manager device 119-1 (e.g., MGR 1), and the backbone network mote 203 communicates with the local network manager device 119-1 over a serial port, for example. Other types of network interfaces between the backbone network motes and the local network manager devices may be used without departing from the scope of the disclosure. The local network manager device 119-1 (e.g., MGR 1) communicates with the nodes of the lower sub network 101-1 (e.g., net 1 motes). In some aspects, the backbone network mote 205 (e.g., MOTE 2) may not communicate with the local network manager device 119-1 (e.g., MGR 1), but rather can only communicate with the local network manager device 119-2 (e.g., MGR 2). Therefore, the backbone network mote 205 (e.g., MOTE 2) only passes information coming in from the local sub network 101-2 (e.g., net 2 motes) directly. However, once messages, if there are any, are passed from the individual local network manager devices to the backbone network motes, then the messages can be passed along to the backbone manager 201.

In one or more implementations, the local sub networks (e.g., 101-1, 101-2, 101-3) are located in geographically distinct locations. The individual local sub networks (e.g., 101-1, 101-2, 101-3) are isolated from one another such that the devices in one local sub network (in a first geographically distinct location) do not communicate with nodes of another local sub network (in a second geographically distinct location). In one or more implementations, the data payloads transmitted between the local network manager devices (e.g., 119-1, 119-2, 119-3) and backbone network motes (e.g., 203, 205, 207) are encrypted. For example, one backbone network mote may not read the data being sent by another backbone network mote. Only the associated local network manager can read that data, and that data can be decoded to plain text for use within that local sub network.

In some implementations, the network manager and the backbone network mote on a common communication to one of the individual local sub networks (e.g., 101-1, 101-2, 101-3) are, or part of, the same hardware device running different software. In one or more implementations, the network manager and the backbone network mote are, or part of, different hardware devices. The network manager (e.g., 119-1, 119-2, 119-3) may be a logical device that is responsible for controlling (e.g., handling in/out communications) the local sub network motes and distributing time to them.

The subject technology provides for measuring a time error in one local wireless mesh network relative to the backbone, thereby capable of tracking the error for that local sub network. The subject technology provides for initiating a measurement at a time that is calculated based on the measured error. As a result, the measurements are occurring at a same time across the local wireless mesh networks.

In operation, the backbone network mote 203 (e.g., MOTE 1) employs the local network manager device 119-1 (e.g., MGR 1) to send a command that contains information to all of the devices in the local sub network 101-1 (e.g., net 1) by invoking an API with the local network manager device 119-1. For example, the backbone network mote 203 sends a message through the local network manager 119-1 to the motes in the local sub network 101-1. In this respect, the local network manager 119-1 is passive, in which the local network manager 119-1 acts as a data ingress/egress to the local sub network 101-1. One message may be sent to all devices by a broadcast transmission in some implementations, or the message may be sent to each device individually by a unicast transmission in other implementations. The backbone network mote 203 (e.g., MOTE 1) measures the drift rate of that local sub network 101-1 via the local network manager device 119-1, and the backbone network mote 203 determines that it has to send a message into the local sub network 101-1 to notify the devices of a correction to their timing. Whether the correction relates to the rate at which the devices are obtaining measurements, or the correction relates to the mapping of that local sub network's current drift, the backbone network mote 203 can push that correction information for the local network manager device 119-1 to make the corrections locally without requiring additional interactions by the backbone network mote 203. In some aspects, the backbone network mote 203 sends correction information into that network so that all of the devices in the local sub network 101-1 receive the message. The local sub network motes are then able to use that message to schedule their own measurements.

In one or more implementations, devices in the first local sub network 101-1 (e.g., net 1 motes) are sending data that is encrypted and sent to their associated network manager device 119-1 (e.g., MGR 1). The data thereafter becomes plain text when the data is passed to the first backbone network mote 203 (e.g., MOTE 1), and backbone network mote 203 encrypts the data again and sends the encrypted data to the backbone manager 201. The packets that are outgoing from the local sub networks (e.g., 101-1, 101-2, 101-3) in an encrypted form are then decoded once the outgoing packets reach their respective backbone network mote. Anything that is transmitted across the backbone network and the local sub network is encrypted, and not viewable by (or shared with) any of the other backbone network motes with the exception of the backbone manager 201.

Passing a correction for either the time and/or time interval to the local sub network motes can facilitate how each of the local network manager devices would schedule their measurements individually so they end up making their measurements at relatively the same time. For example, the local network manager device 119-1 (e.g., MGR 1) may be 10 minutes behind with respect to the backbone network time, and is drifting at a rate of 40 ppm fast (or +40 ppm), which means that the local sub network gains 1.2 ms every 30 seconds relative to the backbone. In one or more implementations, the backbone network mote 203 (e.g., MOTE 1) sends commands to the motes of the local sub network 101-1 (e.g., net 1 motes) through their local network manager device 119-1 (e.g., MGR 1) in order to control their behavior. In some implementations, a backbone network mote provides a clock offset correction that adjusts a clock of a network manager device relative to the backbone network time by a predetermined offset based on timing information from the network manager device. In some aspects, the clock offset is a difference between the clock of the network manager device and the backbone network time. For example, the backbone network mote 203 pushes a message to the local network manager device 119-1 that indicates a clock offset of 10 minutes delta plus an indication that the devices of the local sub network (e.g., 101-1) underneath the local network manager device 119-1 would have to make a measurement at an interval of 30 seconds plus 1.2 ms because that is the rate at which the local sub network 101-1 is drifting relative to the backbone network time. The communication conveyed between the backbone network mote 203 and the local network manager device 119-1 is different from the next backbone network mote 205 (e.g., MOTE 2) communicating with its corresponding network manager device 119-2 (e.g., MGR 2) because that backbone mote is measuring that manager's local properties and pushing a correction into that local sub network (e.g., 101-2). In this respect, the backbone network mote 205 (e.g., MOTE 2) may have a different set of measurements compared to the measurements obtained by the backbone network mote 203. For example, the values may be the opposite, where the local network manager device 119-2 (e.g., MGR 2) is 10 minutes ahead of the backbone network time, and is drifting at a rate of 40 ppm slow (or −40 ppm). The backbone network mote 205 (e.g., MOTE 2) would then notify the local sub network 101-2 that the devices of that network would have to obtain a measurement that occurs 10 minutes earlier than the backbone network time (or relative to every other device) because the devices are determined to be running 10 minutes fast, and the measurements would have to occur every 30 seconds minus 1.2 ms to account for the relatively slow drift. The individual corrections to each of the local sub networks' internal representation of the network time can help achieve time synchronization across the different mesh networks.

In some implementations, the subject technology provides for measuring the error, and then using the error to guide measurement synchronization. For example, a backbone network mote (e.g., 203, 205, 207) may determine an error to calculate the rate at which measurements are taken by the local mesh networks (e.g., 101-1, 101-2, 101-3). In one or more implementations, the backbone network mote (e.g., 203, 205, 207) measures the difference and pushes that measurement to the local network manager (e.g., 119-1, 119-2, 119-3). In some aspects, initiating a measurement with the network manager devices may necessitate a clock offset to be pushed so the network manager devices are all in lock step. Thereafter, when the offset is pushed to the network manager devices, the backbone network mote (e.g., 207) measures the drift from its corresponding network manager (e.g., 119-3). For example, the backbone network mote may determine a rate at which a clock of the network manager device is drifting in time relative to the backbone network time based on timing information from the network manager device. In this respect, the backbone network mote (e.g., 203, 205, 207) may correct the error by adjusting a rate at which measurements are made at motes of the local mesh networks (e.g., 101-1, 101-2, 101-3), thus leaving the network manager device (e.g., 119-1, 119-2, 119-3) to drift, for example. In some implementations, the backbone network mote performs a combination of pushing offset correction information to align the network manager devices to one another, and pushing drift rate correction information to enable each of the network manager devices to initiate measurements at the calculated times. In some implementations, the drift rate correction adjusts a rate at which the clock of the network manager device is drifting in time relative to the backbone network time. In some implementations, the backbone network motes (e.g., 203, 205, 207) that measure the local network manager devices (e.g., 119-1, 119-2, 119-3) in the backbone can detect when there are temperature changes in a local sub network device or rate changes in the network manager. In some aspects, once a backbone network mote makes measurements, the drift rate correction information is determined locally by the backbone network mote.

In some aspects, the motes in the backbone can be measuring their manager devices more often than they may pushing time information into the local sub networks because the backbone network motes only have to push the correction information when a change has been detected. Initially, if things are staying at temperature and the drift is relatively bounded, then the backbone network mote may only make a couple of corrections early in the process. Thereafter, once that local sub network is aligned with a current drift rate, and as long as the drift rate does not change, the backbone network mote may not have to change anything with respect to the local network manager.

In some aspects, the subject system attempts to achieve some time accuracy but rather spends as little communication traffic as minimally expected to conserve power and/or resources. In some aspects, the rate at which messages are pushed to the local sub networks is based on an amount of communication traffic programmed to send the messages. In other aspects, in determining whether to send both the offset correction information and the drift rate correction information to the local sub networks may also be based on the amount of communication traffic programmed to send both types of information. For example, both types of information are pushed to the local sub networks when the amount of communication traffic does not exceed a predetermined threshold.

In operation, a backbone network mote (e.g., 203, 205, 207) measures both the temperature of a local network manager (e.g., 119-1, 119-2, 119-3, respectively) and the drift rate that is tracking the error of the local network manager, and uses that information to decide when to push down additional corrections to the lower sub networks or when to query the backbone manager for additional items. Depending on how much degree of measurement error is desired by the backbone network mote, the backbone network mote can select an update rate of how often the backbone network mote can probe the local network manager. In some aspects, the backbone network mote (e.g., 203) may measure the time of the local network manager (e.g., 119-1) at an interval based on its time base, and measure the error of the other local network manager (e.g., 119-3) relative to that. Depending on how much that device (e.g., 119-1) is drifting, it will have accumulated a certain amount of error in a particular interval. If the backbone network mote (e.g., 203) wants to balance the error, the accumulated amount of error provides an indication of how often to make corrections. When the drift rate changes, it depends on the magnitude of the change for the backbone network mote to know when to make a new correction to minimize a particular error. For example, if a device is drifting 40 ppm in one direction, and the next time that a measurement is taken indicates that the device is now drifting 40 ppm in the opposite direction, the backbone network mote has to make a correction fairly quickly to account for the 80 ppm delta. In some aspects, because the drift swung significantly over time, the backbone network mote may have to align the offset value for the device because of the rather dramatic change that occurred between the measurements.

The source of drift due to temperature, aging, mechanical vibrations, and other phenomenon can alter the frequency of oscillator crystals. One of the primary drivers of the drift rate change is temperature. In some examples, the wireless mesh networks may coexist on a train car, where the devices associated with the networks may be physically located on individual train cars that experience different temperatures over time. For example, a first train car with a first subset of devices in a first mesh network may be exposed to direct sunlight, a second train car with a second subset of devices in a second mesh network may be in the shade, a third train car with a third subset of devices in a third mesh network may be in a tunnel that is hot from gases from the train, and a fourth train car with a fourth subset of devices in a fourth mesh network may be outside in freezing temperatures. In this respect, measurements for drift rate may be retaken at different times depending on the changes in temperature with respect to each of the local network manager devices. Another smaller component for changes in drift over time is aging. For example, as the crystals (e.g., oscillators) in the system run for a significantly long time, they move enough to disrupt their alignment with other crystals. In another example, if these devices are mounted on different parts of train cars, some may experience a vibratory load that is greater than others that can cause them to drift relative to each other.

The fundamental rate at which a crystal is vibrating does not change. Rather, the subject technology provides for measuring the time produced by the crystal relative to a higher precision source. In this respect, the subject technology provides for keeping track of the error, and using that error to adjust the behavior of devices in individual mesh networks so that their behavior is synchronized to the correct time or time interval. The crystal itself can be kept free-running and can drift freely. The subject system does not control the frequency of the crystal, but rather, the subject technology provides for controlling an internal representation of the abstract clock derived from the crystal frequency. The internal representation is corrected rather than correcting the driving input. In some aspects, to bound the error on the measurements to the local sub networks, there is a combination of pushing offset correction and rate correction that can be done to minimize the error. The rate at which these corrections are pushed into the local sub networks can be used to bound the error.

In other implementations, a controller (e.g., the backbone manager 201 or the backbone network motes 203, 205, 207) can push the drift rate and have the devices act on that information instead of the controller pushing the trigger of when to measure. Rather than using the drift to set the rate of measurement, the backbone pushes the drift rate into the local wireless mesh networks so that the devices in the local networks can know what the backbone time base is over time without requiring the backbone network mote to push additional messages over time. In this respect, the measurements may be sent back to the backbone network manager 201, and the backbone network manager 201 then pushes down the correction information to the local sub networks via the local network manager devices (e.g., 119-1, 119-2, 119-3). In some implementations, the backbone network manager 201 pushes the offset correction information and/or the drift rate correction information.

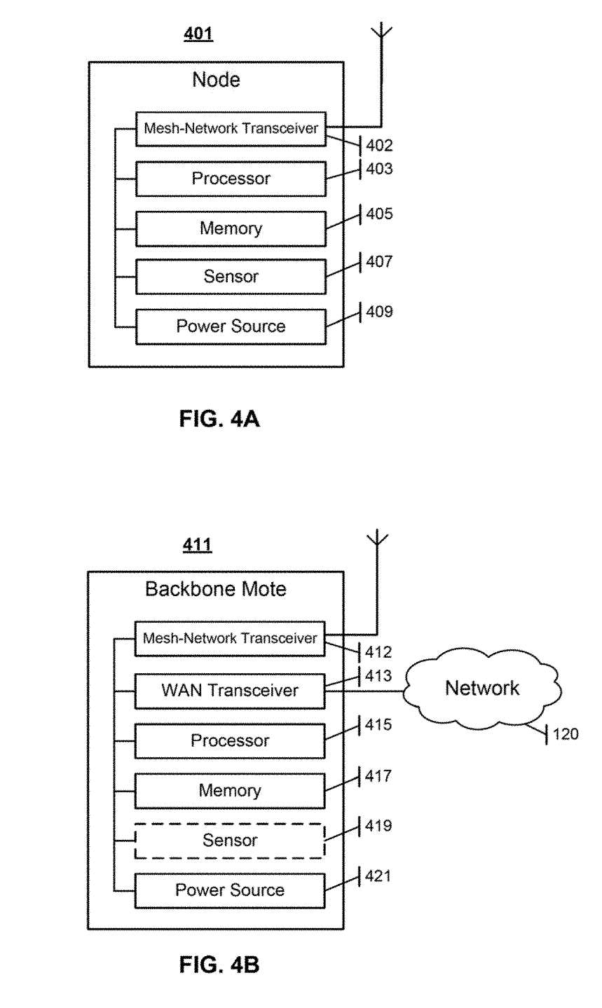

FIG. 3 is a high-level diagram illustrating a structure of a regular data packet 300 used in the wireless mesh network system of FIG. 2 in accordance with one or more implementations. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided.

As shown in FIG. 3, the regular data packet 300 includes the following fields: a field for one or more headers, a field for a short sensor node (i.e., a mote) address or other identifier (ID), a field for data such as sensor data, and a field for message integrity check (MIC) or cyclic redundancy check (CRC) codes.

The regular data packet 300 may be encrypted and authenticated according to a key specific to a sending node (e.g., 203, 205, 207). In some implementations, the packet contents are encrypted and not inspected by forwarding nodes (e.g., 119-1, 119-2, 119-3). The data field of the regular data packet 300 can include all application-related information. In some implementations, the data field includes application-level security information for additional encryption and/or authentication. In some implementations, a sequence number and/or a cryptographic nonce number is included to allow the host application to place into chronological (or other order) the regular data packets that may be received out-of-order.

In a wireless mesh network such as that shown in FIG. 2, two classes of packet may be used: “command” packets are used for communication between the backbone network mote (e.g., 203, 205, 207) and the local network manager devices (e.g., 119-1, 119-2, 119-3) to provide time correction information and enable devices of the local sub networks underneath the local network manager devices to obtain measurements at a time that corresponds to the time correction information, and “data” packets are used for communication between the sensors (attached to the wireless sensor nodes 101-1, 101-2, 101-3) and the host application 121a or 121b. In some implementations, the time correction occurs with either the command packets (e.g., “add this link”) or the sensor data packets. When a local network manager (e.g., 119-1, 119-2, 119-3) receives a command packet originating at a backbone network mote (e.g., 203, 205, 207, respectively), the network manager may strip away the headers and encryption and forwards the data (e.g., correction information) to the local sub network nodes (e.g., 101-1, 101-2, 101-3) for consumption. In some implementations, each packet gets acknowledged by the recipient, in which the time correction is contained in the acknowledgment packet. In other implementations, the packet contents of the regular data packet 300 may contain the clock offset correction and drift rate correction in a same payload, or the clock offset information and the drift rate correction may be stand-alone payloads and transmitted in separate data packets.

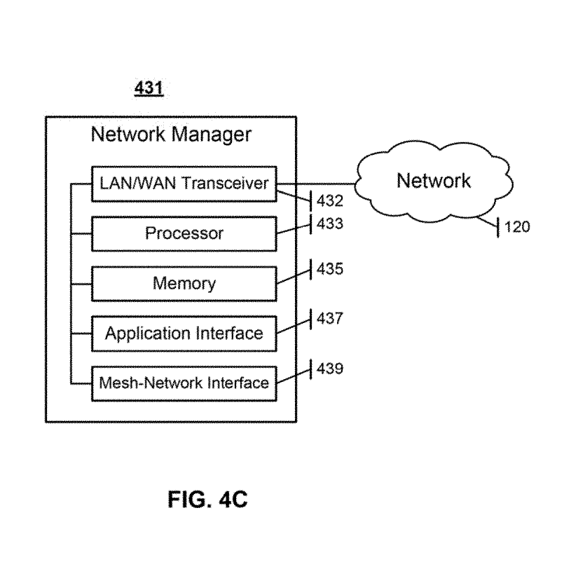

FIGS. 4A-4C show high-level functional block diagrams of illustrative components or devices of the wireless mesh network systems of FIGS. 1 and 2. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided.

FIG. 4A shows an example of a node 401 such as a node 107, 109, 111, 113, or 115 used in the network system of FIG. 1, and such as nodes that belong to wireless mesh networks 101-1, 101-2, and 101-3 of FIG. 2. For example, as depicted in FIG. 4A, the nodes 107, 109, 111, 113 and 115 may be devices that are associated with the wireless mesh network 101 and are managed by the network manager 119. The node 401 includes a processor 403 (e.g., a microprocessor) and a memory 405 that provide processing capabilities. The memory 405 stores application programs and instructions for controlling operation of the node 401, and the processor 403 is configured to execute the application programs and instructions stored in the memory 405. A power source 409, such as a battery, transformer, solar cell(s), dynamo, or the like, provides electric power for powering the operation of the node 401.

Additionally, the node 401 can include a sensor 407 producing sensing or measurement data that is provided to the processor 403 and/or stored in memory 405. The node 401 can additionally or alternatively include an actuator (e.g., a motor, valve, or the like) or other operational output (e.g., a display) that is controlled by the processor 403. The node 401 further includes a transceiver 402 that enables communication across the network (e.g., a wireless mesh-network) with other nodes (e.g., 203, 205, 207). As shown in FIG. 4A, the transceiver 402 is a wireless transceiver connected to an antenna and configured for wireless communication; in other embodiments, the transceiver 402 may be a wired transceiver. The various components of the node 401 are communicatively connected to each other (e.g., via a bus or other communication lines), and are electrically connected to the power source 409 to receive operating power.

FIG. 4B shows a high-level functional block diagram of an example of a backbone mote 411 such as the backbone network motes 203, 205, 207 used in the wireless mesh network system of FIG. 2. For example, as depicted in FIG. 4B, the backbone network motes 203, 205, and 207 are devices that are associated with a backbone network and are managed by the backbone network manager 201. The backbone mote 411 includes components substantially similar to those of the node 401, including a mesh-network transceiver 412, a processor 415 (e.g., a microprocessor), a memory 417, an optional sensor, and a power source 421. Such components of the backbone mote 411 are substantially similar to corresponding components of the node 401, and reference can be made to the description of the node 401 for detailed information on the components and their function. The backbone mote 411 optionally includes a sensor, actuator, or other operational output that is controlled by the processor 415, similarly to the node 401.

Additionally, the backbone mote 411 can include dual transceivers: a first transceiver 412 (e.g., a mesh-network transceiver) configured for communication with wireless nodes of the wireless mesh network, and a second transceiver 413 (e.g., a WAN transceiver) configured for communication outside of the mesh-network such as communications with the local network manager devices (e.g., 119-1, 119-2, 119-3) or application(s) 121a/121b (e.g., via the network 120). In our example, the first transceiver 412 may be a wireless transceiver, while the second transceiver 413 may be a transceiver configured for wired communications (e.g., a transceiver compatible with Ethernet standards) directly with the network manager devices (e.g., 119-1, 119-2, 119-3) or indirectly via one or more network(s) 120. While two transceivers are shown in FIG. 4B, some embodiments may include a single transceiver performing both communications functions, while in other embodiments communications with the network manager devices (e.g., 119-1, 119-2, 119-3) may be via a direct wired link.

In both FIGS. 4A and 4B, the sensor 407 and power source 409 are shown as being located within the node 401 and backbone mote 411. More generally, the sensor 407 and power source 409 may be external to the node 401 and backbone mote 411, but may be connected to the node 401 and backbone mote 411 so as to communicate sensor data to the node 401 and backbone mote 411.

FIG. 4C shows a high-level functional block diagram of an example of a network manager 431 such as network manager devices 119-1, 119-2, 119-3 used in the wireless mesh network system of FIG. 2. The network manager 431 controls operations of the mesh network, and serves as an interface between the network and the outside (e.g., as an interface between the network and external application(s) 121a/121b). Specifically, all communications between the mesh network and external applications 121a/121b may flow through the network manager 431, or otherwise be controlled by the network manager 431.

The network manager devices 119-1, 119-2, 119-3 is shown in FIG. 2 as being a separate entity from the backbone network motes 203, 205, 207, respectively, and as being physically separate from the backbone network motes. In such implementations, the network manager devices 119-1, 119-2, 119-3 and the backbone network motes are separate entities and may be communicatively connected via a communication cable (as shown), one or more wired or wireless network(s), and/or one or more wireless communication links. In other implementations, the network manager devices 119-1, 119-2, 119-3 may be co-located with one backbone network mote, for example within a same device casing. In such implementations, the network manager devices 119-1, 119-2, 119-3 and backbone network mote may have distinct processors, may be mounted on distinct circuit boards, and may be communicatively connected by wire traces between the circuit boards. In further implementations, the network manager devices 119-1, 119-2, 119-3 may execute on a same processor as a backbone network mote.

The network manager 431 includes a processor 433 (e.g., a microprocessor) and a memory 435 that provide processing capabilities. The memory 435 stores application programs and instructions for controlling operation of the network manager 431, and the processor 433 is configured to execute the application programs and instructions stored in the memory 435 and control operation of the manager 431.

Additionally, the network manager 431 includes a communication interface such as a transceiver 432 for communication via network(s) 120. For example, the transceiver 432 may be a local transceiver such as a UART or LAN connection. While a single transceiver 432 is shown in FIG. 4C, the network manager 431 can include multiple transceivers, for example in situations in which the network manager 431 communicates using different communications standards or protocols, or using different networks or communications links, with the backbone network motes and/or the application(s) 121a/121b. For instance, a dedicated communication interface 439 (e.g., a dedicated port) can be included for communication with the backbone network mote(s) of the mesh network. As shown in FIG. 4C, the transceiver 432 is a wired transceiver connected to network 120; in other embodiments, the network manager 431 includes one or more wireless transceivers connected to antennas and configured for wireless communication.

The various components of the network manager 431 are communicatively connected to each other (e.g., via a bus or other communication lines), and are electrically connected to a power source to receive operating power.

The network manager 431 further functions as an operational gateway or interface between the mesh network and the outside—and in particular as an interface for application(s) 121a/121b interfacing with the local sub network nodes. In some implementations, the mesh network interface can be, or be a part of, an AP (e.g., 103, 105) or a connection to an AP. For this purpose, the application interface 437 may be executed on processor 433. The application interface 437 can receive data and information from the network (e.g., from backbone network mote(s), and/or from local sub network nodes), format or process the data to put it in a format useable by the application(s) 121a/121b, and provide the raw or processed data to the application(s) 121a/121b. In this regard, the network manager 431 and application interface 437 can receive data and information from nodes, and can forward data received from such nodes to the application(s) 121a/121b. The application interface 437 can further receive data, information, or control information from the application(s) 121a/121b, format and process the data, information, or controls to put them in a format useable by the backbone network mote(s) and local sub network nodes, and provide the processed data, information, or controls to the backbone network mote (s) and local sub network nodes.

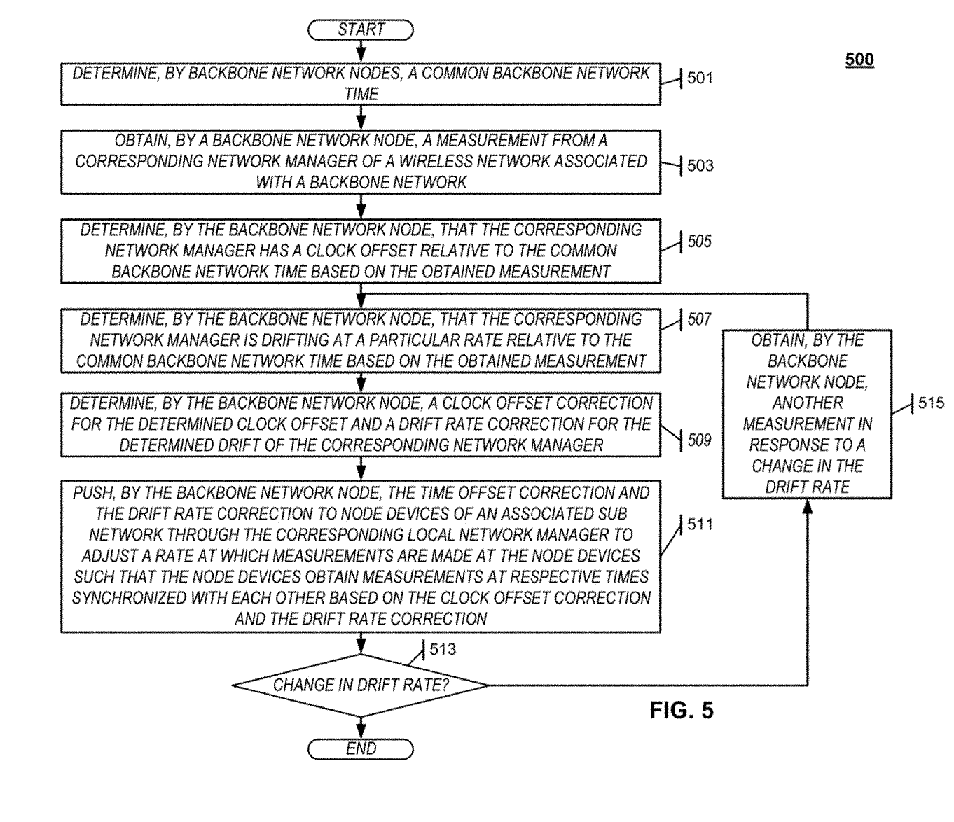

FIG. 5 is a high-level flow diagram showing steps of an example process 500 illustrating the functioning of the wireless mesh network system of FIG. 2 in accordance with one or more implementations. Further for explanatory purposes, the blocks of the sequential process 500 are described herein as occurring in serial, or linearly. However, multiple blocks of the process 500 may occur in parallel. In addition, the blocks of the process 500 need not be performed in the order shown and/or one or more of the blocks of the process 500 need not be performed. Also, other fabrication operations may be introduced.

The process 500 begins with the backbone network nodes (e.g., 203, 205, 207) agreeing to a time to initiate measurements of their corresponding network manager devices (501). From the measurement point of view, all of the backbone network motes (e.g., 203, 205, 207) agree to a common backbone network time. Each of the backbone network motes then measure a corresponding local network manager and measures the drift of the local network manager. In this respect, a backbone network node (e.g., 203) obtains a measurement from a corresponding local network manager (e.g., 119-1) (503). The backbone network node (e.g., 203) determines that the corresponding local network manager (e.g., 119-1) has a clock offset relative to the common backbone network time based on the obtained measurement (505). The backbone network node (e.g., 203) then determines that the corresponding local network manager (e.g., 119-1) is drifting at a particular rate relative to the common backbone network time based on the obtained measurement (507). The backbone network node (e.g., 203) determines a clock offset correction for the determined clock offset and a drift rate correction for the determined drift for the corresponding local network manager (e.g., 119-1) (509). The backbone network node (e.g., 203) then pushes the clock offset correction and the drift rate correction to the corresponding local network manager to enable devices of an associated local sub network to obtain measurements at a time that corresponds to the clock offset correction and the drift rate correction (511). In some aspects, the process 500 includes determining whether there is a change in the drift rate (513). In the event that a change in the drift rate is detected, the process 500 proceeds to step 515, and thereafter proceeds back to step 507. For example, the backbone network node (e.g., 203) obtains another measurement of the local network manager (e.g., 119-1) in response to the change in the drift rate (515). Otherwise, the process 500 terminates following the step 513.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method of synchronizing measurements across networks, comprising:
receiving, by a mote of a backbone network, timing information from a network manager device of a wireless mesh network associated with the backbone network;
determining, by the mote of the backbone network, a rate at which a clock of the network manager device is drifting in time relative to a backbone network time of the backbone network from the received timing information; and
transmitting, by the mote of the backbone network, based on the determined rate, correction information to devices managed by the network manager device through the network manager device to adjust a rate at which measurements are made at the devices such that the devices obtain measurements at respective times synchronized with each other based on the correction information.

2. The method of claim 1, further comprising:
determining a clock offset between the clock of the network manager device and the backbone network time from the received timing information, wherein the correction information provides an indication of the determined clock offset.

3. The method of claim 1, further comprising:
receiving, by a plurality of motes of the backbone network, different timing information from a plurality of network manager devices of different wireless networks associated with the backbone network; and
determining, by each of the plurality of motes of the backbone network, a clock offset between a clock of a corresponding network manager device of the plurality of network manager devices and the backbone network time from the received timing information, wherein each of the plurality of network manager devices has a different clock offset relative to the backbone network time.

4. The method of claim 1, further comprising:
determining the backbone network time based on an agreement on a common time among a plurality of motes of the backbone network.

5. The method of claim 1, further comprising:
determining whether there is a change in the determined rate within a prescribed time period; and
obtaining additional rate information from the network manager devices when a change in the determined rate within the prescribed time period was determined.

6. The method of claim 5, further comprising:
modifying the correction information to provide a change in the determined rate for the network manager device; and
transmitting the modified correction information to the network manager device.

7. The method of claim 1, further comprising:
determining an error based on a difference between an internal representation of the clock associated with the network manager devices and the backbone network time; and
calculating a rate at which measurements are taken by node devices of the wireless mesh network associated with the network manager devices based on the determined error.

8. The method of claim 1, further comprising:
sending a clock offset to the network manager device;
aligning the clock of the network manager devices with other network manager devices associated with different wireless mesh networks based on the clock offset; and
measuring the rate of the network manager devices with the clock of the network manager device adjusted by the clock offset.

9. The method of claim 1, further comprising:
determining whether to send both a clock offset correction and a drift rate correction to node devices of the wireless mesh network associated with the network manager devices based on an amount of communication traffic programmed to send both types of information, and wherein the both types of information are pushed to the node devices when the amount of communication traffic does not exceed a predetermined threshold.

10. A mesh network system comprising:
a plurality of motes of a backbone network, each of the plurality of the motes of the backbone network including a processor and a wireless transceiver configured for wireless communication with the backbone network; and
a plurality of network manager devices communicatively connected to the plurality of motes of the backbone network and each of the plurality of network manager devices is configured to manage operation of an individual wireless mesh network including node devices of the individual wireless mesh network,
wherein each of the plurality of motes of the backbone network is operative to receive timing information from respective ones of the plurality of network manager devices and transmit a clock offset correction and a drift rate correction to node devices managed by each of the plurality of network manager devices through the respective ones of the plurality of network manager devices to adjust a rate at which measurements are made at the node devices such that the node devices obtain measurements at respective times synchronized with each other based on the clock offset correction and the drift rate correction.

11. The mesh network system of claim 10, wherein the clock offset correction adjusts a clock of a network manager device relative to a backbone network time by a predetermined offset based on the timing information, and wherein the drift rate correction adjusts a rate at which the clock of the network manager device is drifting in time relative to the backbone network time.

12. The mesh network system of claim 10, further comprising:
a backbone network manager device communicatively connected to the backbone network and configured to manage operation of the backbone network and the plurality of motes of the backbone network.

13. The mesh network system of claim 10, wherein the individual wireless mesh network comprises a plurality of network node devices, each of the plurality of network nodes including a processor and a wireless transceiver configured for wireless communication with other network node devices of the individual wireless mesh network.

14. The mesh network system of claim 10, wherein each of the plurality of motes of the backbone network determines the drift rate correction for a corresponding network manager device of the plurality of network manager devices from the received timing information.

15. The mesh network system of claim 10, wherein each of the plurality of motes of the backbone network obtains measurements from a corresponding network manager device of the plurality of network manager devices, wherein the measurements are sent back to a backbone network manager device communicatively coupled to the plurality of motes of the backbone network, and wherein the backbone network manager device pushes down at least one of the clock offset correction or the drift rate correction to the individual wireless mesh networks via the plurality of network manager devices.

16. The mesh network system of claim 15, wherein the backbone manager device pushes one or more of the clock offset correction or the drift rate correction.

17. The mesh network system of claim 15, wherein the plurality of motes of the backbone network measure respective ones of the plurality of network manager devices at a first rate, wherein the plurality of motes of the backbone network push the clock offset correction and the drift rate correction to a plurality of network node devices via the plurality of network manager devices at a second rate, and wherein the first rate is greater than the second rate.

18. A mesh network system, comprising:
means for determining a common backbone network time;
means for obtaining timing information from a network manager device associated with a wireless mesh network;
means for determining that a clock of the network manager device has an offset relative to the common backbone network time based on the obtained timing information;
means for determining that the clock of the network manager device is drifting in time relative to the common backbone network time based on the obtained timing information;
means for determining a clock offset correction for the determined clock offset and a drift rate correction for the determined drifting of the network manager device; and
means for pushing the clock offset correction and the drift rate correction to node devices of the associated wireless mesh network through the network manager device to adjust a rate at which measurements are made at the node devices such that the node devices obtain measurements at respective times synchronized with each other based on the clock offset correction and the drift rate correction.

19. The mesh network system of claim 18, further comprising:
means for obtaining a temperature measurement associated with the network manager device;
means for determining whether there is a change in temperature based on the obtained temperature measurement; and
means for detecting a change in the determined drifting for the network manager device when a change in the temperature was determined.

20. The mesh network system of claim 18, further comprising:
means for determining whether a change in the rate of the determined drifting has occurred;
means for determining a magnitude of the change when the change was determined to have occurred; and
means for determining that an additional correction is to be applied to the clock of the network manager device when the magnitude exceeds a predetermined threshold.
